(19) United States
(12) Patent Application Publication
(10) Pub. No.: US 2022/0416527 A1
(43) Pub. Date: Dec. 29, 2022

(54) POWER DISTRIBUTION SYSTEM

(71) Applicant: INTELLIGENT GROWTH SOLUTIONS LIMITED, St Andrews (GB)

(72) Inventor: Niall SKINNER, St Andrews (GB)

(21) Appl. No.: 17/775,394

(22) PCT Filed: Nov. 10, 2020
(86) PCT No.: PCT/GB2020/052850

§ 371 Date: May 9, 2022

(30) Foreign Application Priority Data
Nov. 11, 2019 (GB) 1916391.4
Jun. 23, 2020 (GB) 2009575.8

(51) Int. Cl. H02G 5/02; H02G 5/06

(52) U.S. Cl. CPC H02G 5/025; H02G 5/061

(57) ABSTRACT

There is herein presented an electrical support system for distributing three-phase power, the system comprising a plurality of support sets interconnected by one or more hubs, each support set within the plurality of support sets comprises three conducting elements, each hub of the one or more hubs comprises a plurality of connecting point sets, each connecting point set comprising three connecting points configured to be attached to the three conducting elements of a support set, at least one conducting element within a support set is connected to a hub on at least the first end or second end by a connector, wherein the arrangement of the plurality of support sets within the system is configurable.

### FIELD OF THE INVENTION

The disclosure relates generally to systems for power distribution, specifically to systems for power distribution in industrial or commercial spaces, more specifically to systems for distributing three phase power in industrial or commercial spaces.

### BACKGROUND

Industrial and Commercial spaces tend to be large, open spaces which can be relatively easily divided and configured to suit different applications and uses. The general design of such spaces allows for the simple fitting of room divisions, false ceilings, cabinetry, racking and shelving in a time and cost-efficient manner.

Such fittings are generally self-supporting and independent of building structure to allow for easy removal and reconfiguration as use of the building changes.

Often it is necessary in such open spaces to reconfigure the distribution of electrical power and/or communications as the requirements of the open space changes. For example, in an office environment, it may be necessary to re-arrange office spaces as the number of people working in that space changes, or when a new company moves into that space.

Electrical and communications infrastructure within such buildings is generally less straightforward and much more time consuming to reconfigure. The two primary reasons for this are the specialist skills required in installation and removal due to the high voltages typically involved, requiring qualified electricians to carry out all work, increasing cost and reducing labour availability, and the number of separate systems involved in installation and complexity of fitting, including support system/cable tray for cabling, point to point cabling for all appliances, typically on separate circuits for each type of device, separate mounting systems for each device, for example.

Accordingly, there is a need for a simplified system for providing electrical and communications infrastructure for an internal space that both provides robust support that allows the electrical power and communications requirements for that space to be met, and that is easily reconfigurable as required.

There is also a need for systems that can be readily reconfigured without requiring qualified electricians or similar.

Furthermore, in electrical systems that use three-phase power, there is a requirement to balance the use of the each phase of power. Accordingly, if electrical devices are to be used directly, it is necessary to activate or deactivate devices in groups such that the phase balance for the system is maintained. Therefore, it is not possible to deactivate individual devices, thereby potentially wasting energy.

Therefore, there is a need for improved systems for the distribution of three-phase power.

Embodiments of the described systems are intended to address at least some of these problems.

### SUMMARY

According to a first aspect there is provided an electrical support system for distributing three-phase power, the system comprising a plurality of support sets interconnected by one or more hubs,
each support set within the plurality of support sets comprises three conducting elements, each conducting element within a support set having a first end and an opposed second end, each conducting element within a support set being configured to transmit one phase of a three-phase power supply and the conducting elements within a support set being electrically isolated from one another,
each hub of the one or more hubs comprises a plurality of connecting point sets, each connecting point set comprising three connecting points configured to be attached to the three conducting elements of a support set, and each connecting point within a connecting point set is electrically isolated from the other connecting points within that connecting point set, and each connecting point within a connecting point set being in electrical communication with the corresponding connecting point in at least one of the other connecting point sets within the plurality of connecting point sets,
at least one conducting element within a support set is connected to a hub on at least the first end or second end by a connector,
wherein the arrangement of the plurality of support sets within the system is configurable.

The disclosed system provides a distribution system for three phase power that is configurable and readily re-configurable to meet the needs of a given space. The arrangement of support sets can be changed as required to ensure that power is distributed to those areas that require it should the needs of that space change, as may be required when an office space is reconfigured, or when a retail layout is changed, for example.

Typically, during use the three-phase power distributed by the system is three-phase AC power. Preferably, the three-phase AC power distributed by the system may be low voltage three-phase AC power. For example, the three-phase AC power distributed by the system during use may be extra low voltage power of less than or equal to 50V AC RMS.

The present system combines the support, power transmission and communications functions typically performed by a cable tray, cabling and single device hanging/mounting into a single installation which is simple and quick to install. In embodiments where the three-phase power distributed by the system is extra low voltage three-phase AC power, installation of the described system only requires qualified electricians to make the initial electrical connection between the high voltage grid and a transformer. All other installation steps are classed as extra low voltage and not requiring qualified electricians for installation.

Each support set within the plurality of support sets may consist of three conducting elements. Accordingly, each phase of the three-phase power distributed by the system is transmitted via one conducting element of a given support set.

Each support set within the plurality of support sets comprises a first conducting element, a second conducting element and a third conducting element. The first conducting element of each support set may transmit a first phase of the three-phase power. The second conducting element of each support set may transmit a second phase of the three-phase power. The third conducting element of each support set may transmit a third phase of the three-phase power. Accordingly, each phase of the three-phase power distributed by the system of the present embodiment is distributed by a consistent conducting element in each support set in the system.

In some embodiments, each connecting point within a connecting point set may be configured to be attached to a conducting element of a support set. Accordingly, one connecting point may be configured to be attached to one conducting element.

In some embodiments, one or more of the conducting elements may be elongate conducting elements. All of the conducting elements may be elongate conducting elements. One or more of the conducting elements may be a tubular conducting element. One or more of the conducting elements may be a cylindrical conducting element. All of the conducting elements may be tubular conducting elements. Alternatively, one or more of the conducting elements may be solid elongate conducting elements. All of the conducting elements may be solid elongate conducting elements.

Preferably, the conducting elements comprise an electrically conductive material. The conducting elements may comprise a metal, such as aluminium, iron, copper, steel or alloys thereof. Preferably, the metal is aluminium.

One or more of the conducting elements may be a bus bar. The bus bars for use in the systems described herein include; hollow bus bars; cylindrical bus bars; tubular or substantially tubular bus bars; hollow metal bus bars; tubular or substantially tubular metal bus bars; aluminium tubular or substantially tubular bus bars; aluminium hollow bus bars; copper tubular or substantially tubular bus bars; copper hollow bus bars; metal-coated hollow bus bars and combinations thereof.

In some embodiments, the conducting elements may be arranged in a common plane. Preferably, the conducting elements may be arranged in a vertical common plane. Alternatively, the conducting elements may be arranged in a horizontal plane. The conducting elements may be arranged in plane oriented between the horizontal plane and the vertical plane. For example, the conducting elements may be arranged in a diagonal plane.

The construction of three conducting elements arranged in a vertical plane and suspended at each end of span from hubs provides substantial mechanical strength to the system and allows for fewer suspension points from the roof of the installation area reducing time and cost of installation.

Alternatively, the conducting elements may be arranged in a triangular formation.

The system may comprise a bracing element that extends between two hubs but does not form part of the electrical power distribution network. The bracing element may be provided to provide mechanical strength to the system where an electrical connection is not required. The bracing element may comprise an insulating material that does not substantially conduct electricity. The bracing element may comprise a plastic or similar, for example. The bracing element may be insulated from the electrical power distributed by the system by an insulating connector.

Each hub may be cylindrical and the plurality of connecting point sets may be arranged along the length of the cylindrical hub.

Each hub may comprise at least two connecting point sets. Each hub may comprise at least three connecting point sets. Each hub may comprise at least four connecting point sets. Each hub may comprise at least five connecting point sets. Each hub may comprise at least six connecting point sets. Each hub may comprise at least seven connecting point sets. Each hub may comprise at least eight connecting point sets. The plurality of connecting point sets may be arranged regularly around the hub. The plurality of connecting point sets may be arranged irregularly around the hub.

Each hub may comprise insulation elements arranged between each connecting point within a connecting point set. Each hub may comprise an insulation element arranged between adjacent connecting points within a connecting point set. Accordingly, each connecting point within a connecting point set is electrically isolated from the other connecting points within that connecting point set, and therefore, conducting elements attached to connecting points within a given connecting point set are electrically isolated from one another. The insulating element may comprise a material that is resistant to the transmission of electrical power across the insulating element.

At least one of the one or more of the hubs may comprise an attachment point from which the system can be suspended. The attachment point may be a loop, or hook, for example. The attachment point may be isolated form the connecting points within the connecting point sets of the hub.

The hub may comprise a first end cap and a second end cap. The first end cap may comprise an insulating material. The second end cap may comprise an insulating material. The first end cap may comprise an attachment point. The first end cap may be located at a first end of the hub. The second end cap may be located at a second end of the hub. A central element may extend from the first end cap to the second end cap. The central element may be fastened to the first end cap and the second end cap to thereby produce a compressive force on the first end cap and the second end cap. The first end cap and the second end cap may ensure that the central element is located centrally and that it is isolated from the connecting points of the connecting point sets of the hub.

The system may comprise one or more adapters that are configured to simultaneously connect to each of the conducting elements within a support set to thereby draw three-phase power to thereby power an electrical device connected to the one or more adapter.

The one or more adapter may comprise a conversion element to convert the three-phase power drawn from the support set to single phase power.

The one or more adapter may comprise an AC/DC rectifier element to convert AC power to DC power to thereby power electrical devices that require DC power. The AC/DC rectifier element may be a three-phase AC/DC rectifier element.

The one or more adapter may comprise three fasteners, wherein each fastener is configured to fasten the adapter to a conducting element within a support set. The three fasteners may conduct electrical power to thereby draw electrical power from the support set to the adapter. The one or more adapter may comprise a first fastener, a second fastener and a third fastener. The first fastener may be configured to fasten to a first conducting element. The second fastener may be configured to fasten to a second conducting element. The third fastener may be configured to fasten to a third conducting element. Accordingly, the fasteners of the adapter are adapted to fasten the adapter to each conducting element of a support set. Therefore, the adapter is configured to draw three-phase power from the support set to thereby power an electric device on the adapter.

One or more of the fasteners may be configured to reversibly fasten the adapter to the conducting element. Each fastener may be configured to reversibly fasten the adapter to the conducting element. Therefore, the adapter may be configured to be readily attached, removed and reattached as required.

One or more of the fasteners may be a resilient clip configured to reversibly connect the adapter to the conducting element.

Alternatively, one or more of the fasteners may be a clamp or similar to thereby reversibly clamp the adapter to the conducting element.

The adapter may comprise an electrical device. The electrical device may be a lighting device. The lighting device may comprise an LED or a cluster of LEDs. The electrical device may be a non-lighting device. The non-lighting device may be a device such as cameras, laptops, personal computers (PCs), printers, scanners, dictation machines, telephone answering machines, chargers including mobile-phone chargers, tablet chargers, mobile gaming device chargers, camera and video chargers, TVs, monitors, shavers, hair trimmers, radios, smoke alarms/detectors, CO₂ alarms/detectors, security alarms and sensors such as thermal or motion sensors and the like. Sound systems including either domestic surround sound or whole house systems, as well as large scale commercial or industrial sound systems are also suitable arrangements for power distribution to and remote control management thereof via the system.

Use of adapters that attach to each of the three conducting elements in a support set in the present system reduces energy use as individual or groups of devices may be dimmed or deactivated without having to consider phase balancing, which is normally the case with three-phase power systems, as each device is drawing power equally from each phase.

Where the electrical device includes a camera, motion sensor or thermal sensor, for example, the system may provide the ability to develop ‘smart spaces’ which gather data about how a space is used through the system connected cameras, motion sensors, thermal sensors etc., which can then adapt to the use of the space recorded, or allowing a user to use the data gathered to recommend layout changes to better utilise space, improve flow of people, or improve productivity etc.

One or more conducting element within a support set may comprise an insulating coating or layer. Accordingly, the one or more conducting element may be protected from external elements that could contact the conducting element to thereby draw power from that conducting element. Two or more conducting elements within a support set may comprise an insulating coating or layer. All three conducting elements within a support set may comprise an insulating coating or layer.

In embodiments where one or more conducting elements comprises an insulating coating or layer, one or more fastener of the adapter may comprise at least one cutting element configured to pierce the insulating coating or layer to thereby contact the conducting element to thereby allow the adapter to draw electrical power from the conducting element through the insulating coating or layer.

The connector may comprise a first portion, a contacting element and a second portion. The first portion may be configured to be reversibly fastened to the second portion. The first portion and second portion may form a cavity and the first portion may be configured to allow either the first end or the second of a conducting element to be inserted into the cavity through the first portion. The second portion is configured to attach the connector to a connecting point on a hub. Accordingly, the second portion may comprise a fastener on a side of the second portion opposed to the first portion when the first portion and second portion are fastened together. The contacting element may comprise a recess configured to receive an end of a conducting element. The contacting element may further comprise a plurality of gripping members that may be arranged around the recess.

The first portion may be annular. The first portion may define an aperture through the first portion. The first portion may comprise an annular wall that defines an aperture through the first portion.

The first portion may comprise an interior surface, and the interior surface may comprise a first threaded portion. The second portion may comprise an outer surface and the outer surface may comprise a second threaded portion. The first portion may be fastened to the second portion by screwing the first threaded portion to the second threaded portion.

In embodiments where the first portion comprises an annular wall, the first portion may comprise a channel that runs around a portion of the annular wall. The channel may be open on the interior side of the annular wall. The channel may be open on the exterior side of the annular wall. The channel may be closed on the exterior side of the annular wall. The first portion may comprise an opening that connects the channel to the end of the annular wall. Accordingly, the channel may comprise a proximal end adjacent to the opening and a distal end furthest from the opening. The second portion may comprise a locking formation on the outer surface of the second portion. The first portion may be fastened to the second portion by inserting the locking formation of the second portion into the channel in the annular wall of the first portion via the opening. The first portion may then be rotated such that the locking formation of the second portion is rotated along the channel from the proximal end to the distal end, away from the opening, thereby fastening the first portion to the second portion.

The channel may extend around the diameter of the first portion at right angles to an axis of rotation of the first portion such that the channel remains at a separated from a peripheral edge of the annular wall. In other words, the proximal end of the channel may be at substantially the same distance from the peripheral edge of the annular wall as the distal end of the channel.

The channel may extend around the diameter of the first portion at an angle to the peripheral edge of the annular wall such that the distal end of the channel is further from the peripheral edge than the proximal end of the channel. Accordingly, rotation of the first portion relative to the second portion to move the locking formation of the second portion from the proximal end of the channel to the distal end of the channel may urge the second portion against the first portion, thereby fastening the first portion to the second portion.

The locking formation of the second portion may be integral with the outer surface of the second portion. Alternatively, the second portion may comprise a locking pin receiving formation configured to receive a locking pin to thereby form the locking formation. The locking pin may be secured within the locking pin receiving formation.

The first portion may comprise at least two channels running around at least two portions of the annular wall. The at least two portions of the annular wall may be arranged regularly around the annular wall. For example, in embodiments where the first portion comprises two channels, a first portion may be arranged on an opposed side of the annular wall to the second portion.

The second portion may comprise at least two locking formations arranged to be received into the openings of the at least two channels of the first portion. Accordingly, the second portion may comprise a number of locking formations that corresponds to the number of channels of the first portion.

The second portion may comprise a major element and a minor element. The major element may be of a first diameter and the minor element may be of a second diameter. The first diameter may be greater than the second diameter. The outer surface of the major element may be configured to contact the interior surface of the first portion when the first portion is fastened to the second portion. The outer surface of the minor element may comprise a gripping element. The gripping element may be configured to allow the second portion to be more readily fixed in place whilst the first portion is fastened to the second portion. The gripping element may comprise a flattened portion of the outer surface of the minor element. The gripping element may comprise a patterned portion of the outer surface of the minor element.

During use the second portion may be fastened to a connecting point of a hub. A first end of a conducting element to be attached to the hub may be inserted into the recess of the contacting element and the first end of the conducting element is inserted into the first portion. The first portion may then be fastened to the second portion. As the first portion is fastened to the second portion the plurality of gripping members are urged into contact with the conductive element to thereby from an electrical contact between the conducting element and the contacting element. The contacting element may be urged against the second portion to thereby form an electrical contact between the contacting element and the second portion.

The contacting element may comprise at least two gripping members. The contacting element may comprise at least three gripping members. The contacting element may comprise at least four gripping members. The contact element may comprise at least five gripping members. The contact element may comprise at least six gripping members.

Each gripping member may be deformable. Each gripping member may be resistive. Accordingly, each gripping member may be deflected by the application of a force to the gripping member and once that force is removed, each gripping member may return to its original position.

Each gripping member may comprise an elongate element and a tapered portion. The elongate element may extend from a main body of the contacting element to the tapered portion. Each gripping member may be separated by a gap or space such that each gripping member within the plurality of gripping members may move relative to the one or more other gripping members within the plurality of gripping members. Accordingly, during use the tapered portion of each gripping member within the plurality of gripping members may be contacted by the tapered section of the first portion to thereby deflect the elongate elements such that the tapered portions are urged inward towards the surface of a conducting element to thereby grip the conducting element.

During use the contacting element may abut the second portion such that a surface of the contacting element contacts a surface of the second portion.

The first portion may comprise a hollow cylindrical portion. The hollow cylindrical portion may comprise the annular wall. The hollow cylindrical portion may comprise an internal cavity, a first opening and a second opening. The internal cavity, the first opening and the second opening may correspond to the aperture defined by the annular wall. During use an end of a conducting element may be inserted into the hollow cylindrical portion through the first opening. The internal surface of the hollow cylindrical portion may comprise a tapered section. The tapered section may reduce the diameter of the interior cavity of the hollow cylindrical portion. The tapered section may reduce the diameter of the interior cavity of the hollow cylindrical portion such that the diameter of the interior cavity is at a minimum diameter at the end of the tapered section adjacent to the end of the first portion. The tapered section may reduce the diameter of the interior cavity of the hollow cylindrical portion such that the diameter of the first opening is less than the diameter of the second opening. The tapered section may be located adjacent to the end of the first portion opposed to the end of the first portion that is fastened to the second portion. When the first portion is fastened to the second portion, the tapered section may urge the gripping members towards the conducting element retained within the cavity.

The connector may allow conducting elements to be readily fastened to a hub without requiring forming a wired connection and without requiring the ends of the conducting elements to be machined or otherwise prepared. For example, there is no requirement to provide a taper or other such modification to the or each end of the conducting elements.

Furthermore, this simple method of connecting conducting elements to the system allows one or more conducting elements to be readily added to or removed from the system to allow the system to be reconfigured as required without the need for skilled electricians or similar. In addition, the system can be assembled from multiple points on the system at the same time. For example, conducting elements may be connected to different hubs of the system at the same time, or a first end of a conducting element may be connected to a first hub at the same time as a second end of the conducting element is connected to a second hub. This contrasts with conventional cable and conduit systems where installations must be built out from a single fixed point.

### BRIEF DESCRIPTION OF THE FIGURES

Embodiments of the present invention will now be described, by way of non-limiting example, with reference to the accompanying drawings.

FIG. 1: An electrical support system according to an embodiment;

FIG. 2: An electrical support system according to an embodiment;

FIG. 3: An electrical support system according to an embodiment;

FIG. 4: A schematic cross section of a connector used in the system according to an embodiment;

FIG. 5: A perspective view of a connector used in the system according to an embodiment;

FIG. 6: A schematic cross section of a contact element of a connector used in the system according to an embodiment;

FIG. 7: A perspective view of a contact element of a connector used in the system according to an embodiment;

FIG. 8: A schematic cross section of a first portion of a connector used in the system according to an embodiment;

FIG. 9: A perspective view of a first portion of a connector used in the system according to an embodiment;

FIG. 10: A side view of a second portion of a connector used in the system according to an embodiment;

FIG. 11: A perspective view of a second portion of a connector used in the system according to an embodiment;

FIG. 12: A side view of a hub used in the system according to an embodiment;

FIG. 13: A perspective view of a hub connected to support sets by connectors according to an embodiment;

FIG. 14: A) A perspective view of an adapter used in the system according to an embodiment, B) an exploded view of an adapter used in the system according to an embodiment;

FIG. 15: A) A perspective view of an electrical contact used in an adapter used in the system according to an embodiment, B) a side view of an electrical contact used in an adapter used in the system according to an embodiment;

FIG. 16: a schematic cross section of a connector according to an embodiment;

FIG. 17: a perspective view of a connector according to an embodiment;

FIG. 18: a schematic cross section of a first portion according to an embodiment;

FIG. 19: a perspective view of a first portion according to an embodiment;

FIG. 20: a schematic cross section of a second portion according to an embodiment; and

FIG. 21: a perspective view of a second portion according to an embodiment.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

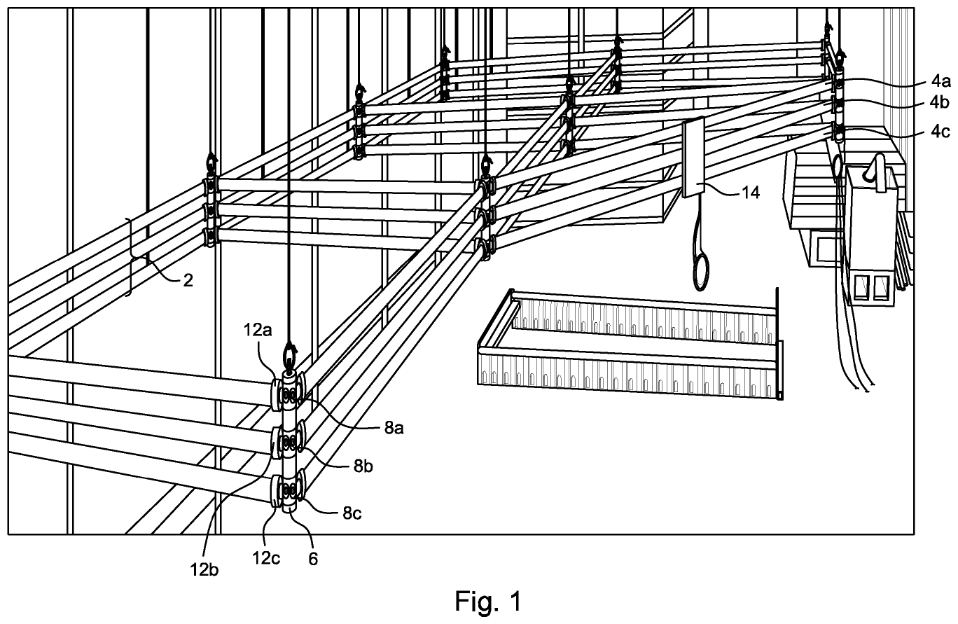

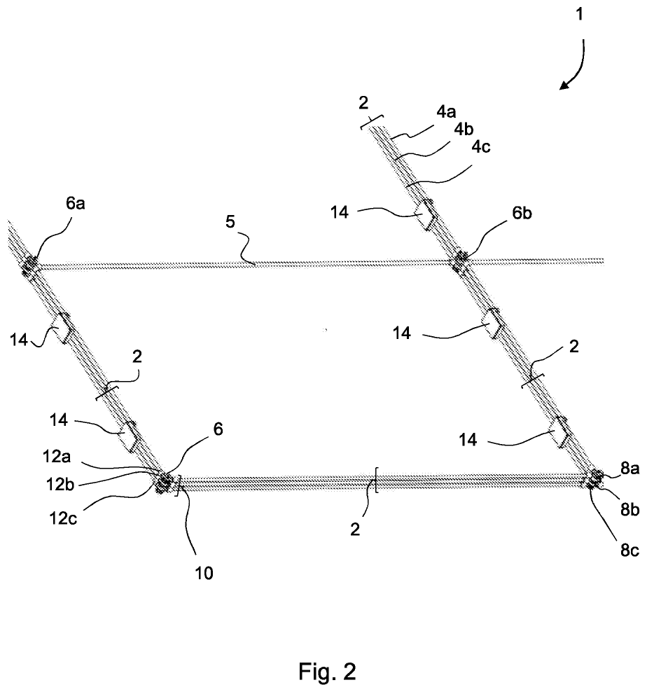

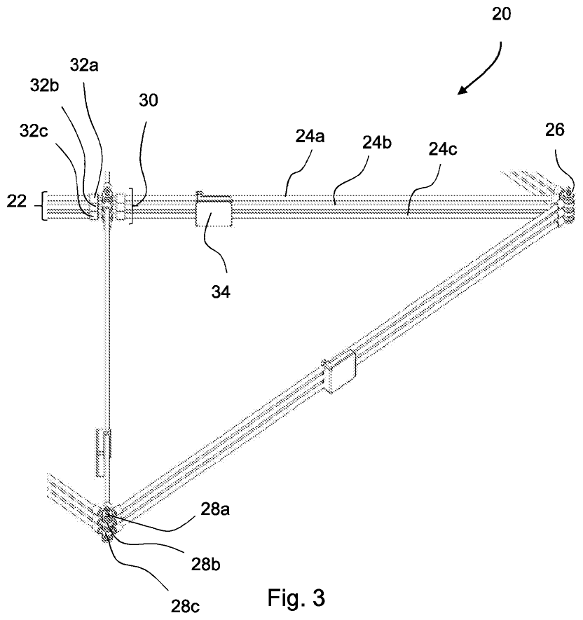

With reference to FIGS. 1 to 3, an electrical support system 1, 20 comprises bus bar groups 2, 22 (acting as support sets) comprising a first bus bar 4a, 24a (acting as a first conducting element), a second bus bar 4b, 24b (acting as a second conducting element), and a third bus bar 4c, 24c (acting as a third conducting element). The bus bar groups 2, 22 are interconnected by hubs 6, 26 to form a network. The hubs 6, 26 comprises groups of connecting points made up of a first connecting point 8a, 28a, a second connecting point 8b, 28b, and a third connecting point 8c, 28c. The first bus bar 4a, 24a is connected to the first connecting point 8a, 28a. The second bus bar 4b, 24b is connected to the second connecting point 8b, 28b. The third bus bar 4c, 24c is connected to the third connecting point 8c, 28c. The bus bars 4a, 4b, 4c, 24a, 24b, 24c of the bus bar groups 2, 22 are connected to the hubs 6, 26 via connectors 12a, 12b, 12c, 32a, 32b, 32c.

The system 1 further comprises a bracing element 5 between two hubs 6a, 6b to provide mechanical strength to the system 1. The bracing element 5 is electrically isolated from the groups of bus bars 2.

During use, the electrical support system 1, 20 transmits three-phase electrical power from a transformer (not shown) to LED lights (acting as electrical devices, not shown) that are supported on attachment boxes 14, 34 that are attached to the bus bar groups 2, 22 at any point along their length.

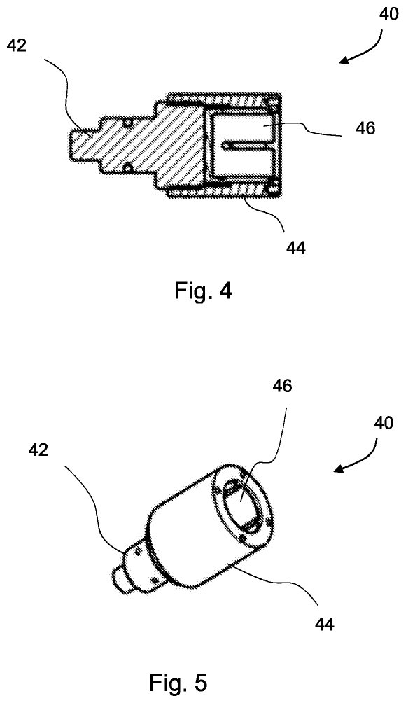

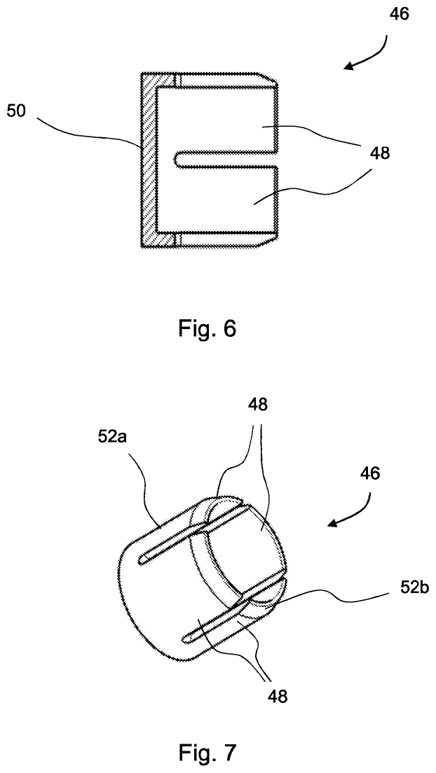

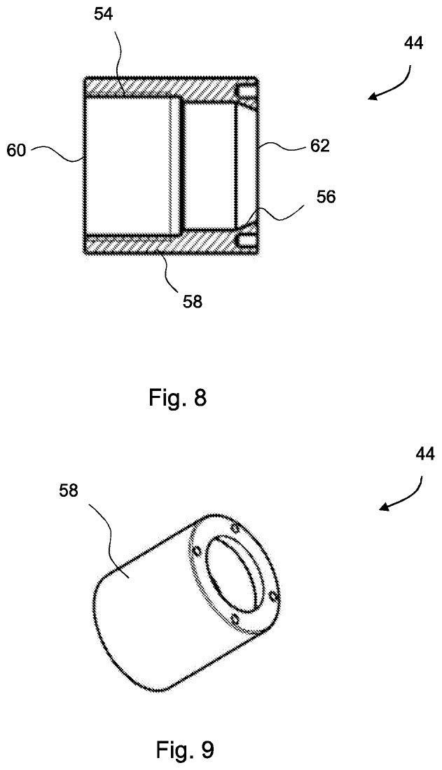

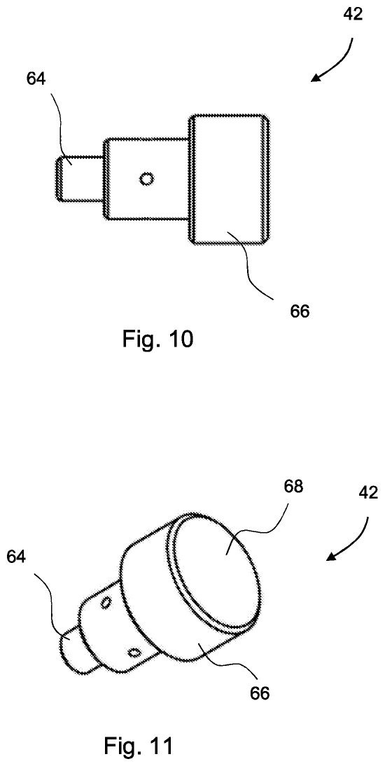

With reference to FIGS. 4 to 11, a connector 40 comprises a stub 42 (acting as a second portion), a nut 44 (acting as a first portion), and a collet 46 (acting as a contacting element). The stub 42 comprises a hub threaded screw 64, a nut threaded screw 66 and a collet contacting surface 68. The nut 44 comprises a hollow cylindrical body 58. The interior of the hollow cylindrical body 58 comprises an internal thread 54 configured to screw onto the nut threaded screw 66 of the stub 42 on one end 60 of the hollow cylindrical body 58, and a tapered portion 56 on the opposite end 62 of the hollow cylindrical body 58. The collet 46 comprises four deformable elements 48 (acting as gripping elements) arranged around a cavity, and a base 50 (acting as a second portion contacting surface). Each deformable element 48 comprises an elongate element 52a, and a tapered element 52b.

During use, the nut 44 is placed over the end of a bus bar that is to be attached to a hub and the collet 46 is placed over the end of a bus bar behind the nut 44. The internal thread 54 of the nut 44 is then screwed onto the nut threaded screw 66 of the stub 42. As the nut 44 is secured to the stub 42 the base 50 abuts the collet contacting surface 68 and the four deformable elements 48 grip the end of the bus bar by being urged by the tapered portion 56 inward (i.e. toward the surface of the bus bar).

As a result, the four deformable elements 48 make an effective electrical contact onto the surface of the bus bar and the base 50 of the collet 46 makes an effective electrical contact onto the collet contacting surface 68 of the stub 42. Finally, the stub 42 makes an effective electrical contact with the hub via the hub threaded screw 64. Accordingly, the connector 40 provides an effective electrical contact between a bus bar of a bus bar group to a hub via a simple action of screwing the nut 44 onto the stub 42, thereby not requiring any wiring or any qualified electricians to attach bus bars to form the system.

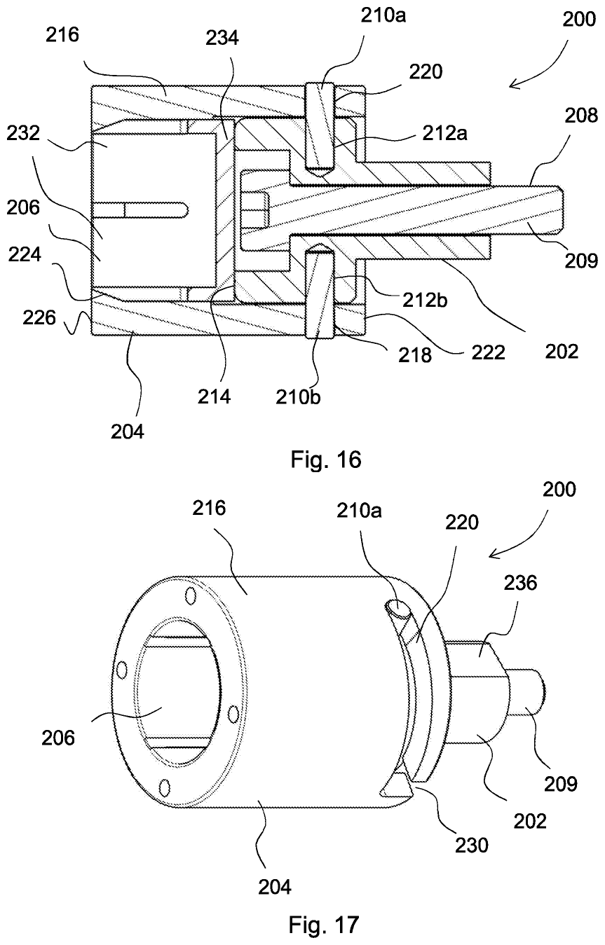

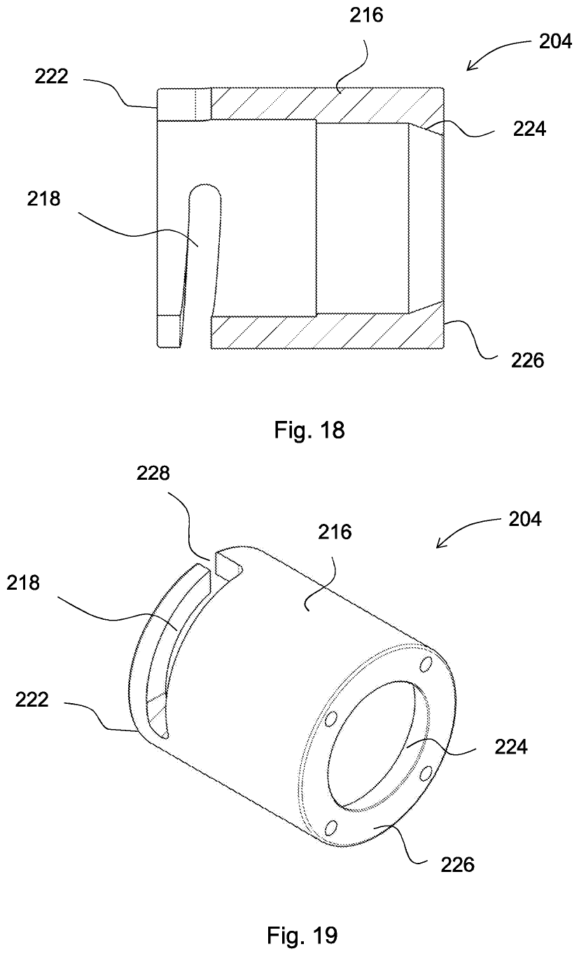

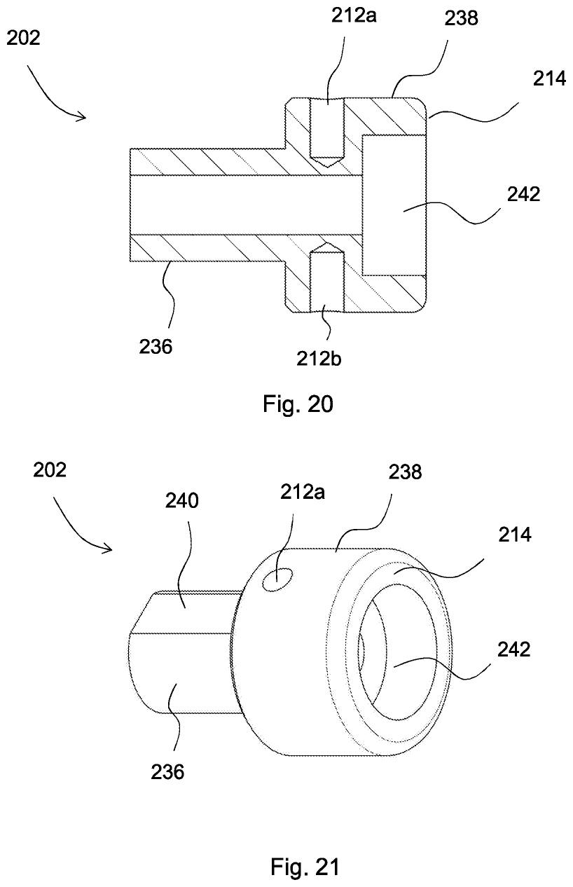

With reference to FIGS. 16 to 21, a connector 200 comprises a stud 202 (acting as a second portion), a nut 204 (acting as a first portion) and a collet 206 (acting as a contact element). The stud 202 comprises a hub threaded screw 208 provided on screw 209 that extends through the stud 202, a first locking pin 210a and a second locking pin 210b, and a collet contacting surface 214. The first locking pin 210a is received within a first pin aperture 212a and the second locking pin 210b is received within a second pin aperture 212b.

The nut 204 comprises a hollow cylindrical body 216. The hollow cylindrical body 216 (acting as an annular wall) comprises a first pin channel 218 and a second pin channel 220 adjacent to a first end 222, and a tapered portion 224 (acting as tapered element) on the opposite end 226 of the hollow cylindrical body 216. The first pin channel 218 comprises an opening 228 and the second pin channel 220 comprises an opening 230. The collet 206 comprises four deformable elements 232 (acting as gripping elements) arranged around a cavity, and a base 234 (acting as a second portion contacting surface).

The stud 202 comprises a gripping portion 236 (acting as a minor portion) and a connecting portion 238 (acting as a major portion). The gripping portion 236 is cylindrical with two flattened sides 240 that allow the user to firmly grip the stud 202. The connecting portion 238 is cylindrical and comprises the first locking pin 210a received within the first pin aperture 212a and the second locking pin 210b received within the second pin aperture 212b. The stud 202 further comprises a recessed portion 242 that is configured to receive the head of a screw 209 or bolt.

During use, the nut 204 is placed over the end of a bus bar that is to be attached to a hub and the collet 206 is placed over the end of a bus bar behind the nut 204. The first locking pin 210a is received into the opening 228 of the first pin channel 218 and the second locking pin 210b is received into the opening 230 of the second pin channel 220. The nut 204 is then rotated such that the first locking pin 210a travels along the first pin channel 228 and the second locking pin 210b travels along the second pin channel 220. The first pin channel 218 and the second pin channel 220 are angled such that as the first locking pin 210a moves along the first pin channel 218 and as the second locking pin 210b moves along the second pin channel 220 the stud 202 is urged into the nut 204, thereby fastening the stud 202 to the nut 204.

As the nut 204 is secured to the stud 202 the base 234 abuts the collet contacting surface 214 and the four deformable elements 232 grip the end of the bus bar by the tapered portion 224 contacting the tapered member of the deformable elements 232 and urging them inward (i.e. toward the surface of the bus bar) to bend the elongate elements of the collet 206 towards the bus bar.

As a result, the four deformable elements 232 make an effective electrical contact onto the surface of the bus bar and the base of the collet 206 makes an effective electrical contact onto the collet contacting surface 214 of the stud 202. Finally, the stud 202 makes an effective electrical contact with the hub via the hub threaded screw 208. Accordingly, the connector 200 provides an effective electrical contact between a bus bar of a bus bar group to a hub via a simple action of screwing the nut 204 onto the stud 202, thereby not requiring any wiring or any qualified electricians to attach bus bars to form the system.

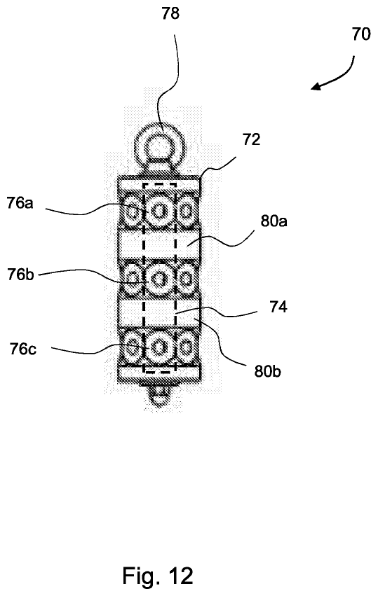

With reference to FIG. 12, a hub 70 comprises a substantially cylindrical body 72 and eight groups of connecting points 74 arranged regularly around the cylindrical body 72, each group of connecting points 74 comprises a first connecting point 76a, a second connecting point 76b, and a third connecting point 76c. The hub 70 further comprises an insulating layer 80a between the first connecting point 76a and the second connecting point 76b, and an insulating layer 80b located between the second connecting point 76b and the third connecting point 76c. Accordingly, the connecting points 76a, 76b, 76c within a group of connecting points 74 are electrically isolated from one another. The hub 70 further comprises an attachment ring 78 from which the system can be suspended. The provision of eight groups of connecting points 74 around the cylindrical body of the hub 70 allows the relative angle between two groups of bus bars attached to the hub 70 to be set by the users' preference or requirements from 45°, 90°, 135° and 180°. Accordingly, the hubs allow the system to be configured and reconfigured to provide electrical power as required by a given space's requirements and as those requirements change over time.

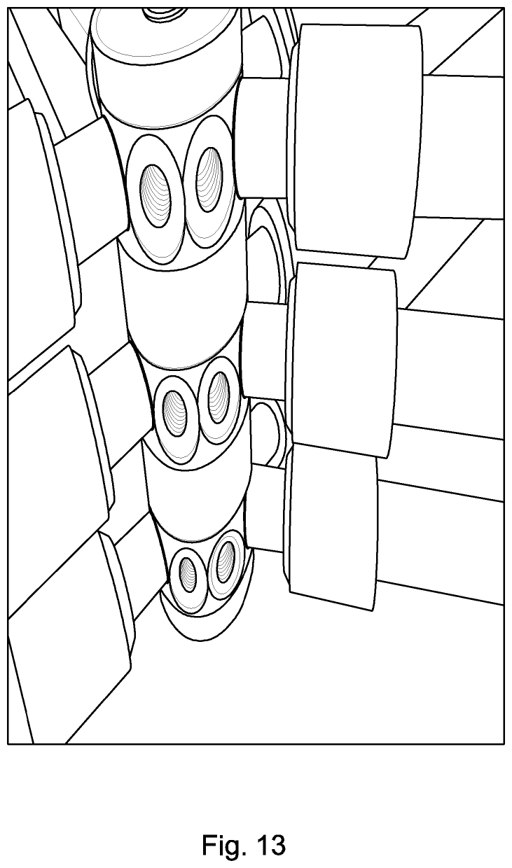

An example hub connected to multiple groups of bus bars is shown in FIG. 13.

The combination of the hubs and connectors used in this system allows the arrangement of bus bar groups in the system to be reconfigured as required and allows the bus bars to be added or removed as required without the need for qualified electricians, especially in embodiments where the system transmits extra low voltage power.

In alternative examples, the electrical devices combined with the attachment boxes include cameras, sensors, wireless communication hubs or routers, alarms or similar, or combinations or of the same. Electrical devices can be readily attached to the groups of bus bars as required by combining them with attachment boxes and directly attaching those attachment boxes to the groups of bus bars.

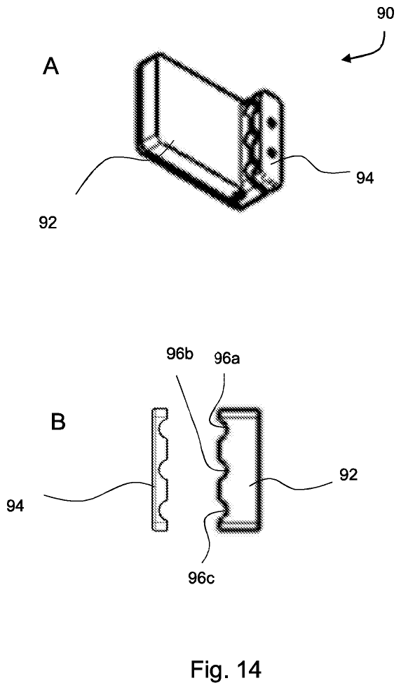

An example attachment box 90 is shown in FIG. 14 and comprises a main body 92 and a coupling member 94. The main body comprises three bus bar receiving elements 96a, 96b, 96c, and the coupling member 94 is configured to fasten onto the three bus bar receiving elements 96a, 96b, 96c. During use the main body 92 is placed against the three bus bars of a bus bar group such that one bus bar is received by one receiving element 96a, 96b, 96c. The coupling member is the fastened to the main body to thereby attach the attachment box to a bus bar group of the system.

An electrical connection is provided between each of the bus bars of the bus bar group and the attachment box via an electrical contact in each of the three bus bar receiving elements 96a, 96b, 96c.

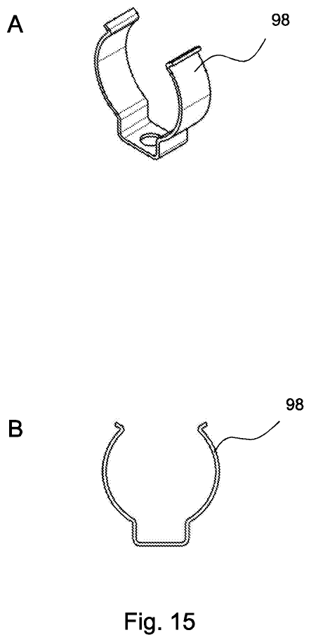

The three bus bar receiving elements 96a, 96b, 96c of the attachment box comprise a clip 98 and the attachment box is clipped to each of the bus bars of a bus bar group to thereby provide an electrical connection between each of the bus bars in a bus bar group and each clip. See FIG. 15. The coupling member 94 is then placed over the clips 98 of each bus bar receiving element 96a, 96b, 96c and fastened to the main body 92.

While there has been hereinbefore described embodiments of the present invention, it will be readily apparent that many and various changes and modifications in form, design, structure and arrangement of parts may be made for other embodiments without departing from the invention and it will be understood that all such changes and modifications are contemplated as embodiments as a part of the present invention as defined in the appended claims.

1. An electrical support system for distributing three-phase power, the system comprising a plurality of support sets interconnected by one or more hubs,
each support set within the plurality of support sets comprises three conducting elements, each conducting element within a support set having a first end and an opposed second end, each conducting element within a support set being configured to transmit one phase of a three-phase power supply and the conducting elements within a support set being electrically isolated from one another,
each hub of the one or more hubs comprises a plurality of connecting point sets, each connecting point set comprising three connecting points configured to be attached to the three conducting elements of a support set, and each connecting point within a connecting point set is electrically isolated from the other connecting points within that connecting point set, and each connecting point within a connecting point set being in electrical communication with the corresponding connecting point in at least one of the other connecting point sets within the plurality of connecting point sets,
at least one conducting element within a support set is connected to a hub on at least the first end or second end by a connector,
wherein the arrangement of the plurality of support sets within the system is configurable.

2. The system according to claim 1, wherein the three-phase power distributed by the system is low voltage three-phase AC power.

3. The system according to claim 1, wherein all of the conducting elements are elongate conducting elements.

4. The system according to claim 3, wherein all of the conducting elements are tubular conducting elements.

5. The system according to claim 1, wherein the conducting elements comprise a metal selected from the group consisting of aluminium, iron, copper, steel or alloys thereof.

6. The system according to claim 1, wherein the conducting elements are arranged in a common plane.

7. The system according to claim 1, wherein each hub may be cylindrical and the plurality of connecting point sets may be arranged along the length of the cylindrical hub.

8. The system according to claim 1, wherein each hub comprises at least four connecting point sets.

9. The system according to claim 1, wherein each hub comprises insulation elements arranged between each connecting point within a connecting point set.

10. The system according to claim 1, wherein at least one of the one or more of the hubs comprises an attachment point.

11. The system according to claim 1 further comprising one or more adapters that are configured to simultaneously connect to each of the conducting elements within a support set to thereby draw three-phase power to thereby power an electrical device connected to the one or more adapter.

12. The system according to claim 11, wherein the one or more adapter comprises an AC/DC rectifier element to convert AC power to DC power to thereby power electrical devices that require DC power.

13. The system according to claim 11, wherein the one or more adapter comprises three fasteners, wherein each fastener is configured to fasten the adapter to a conducting element within a support set.

14. The system according to claim 13, wherein the three fasteners may conduct electrical power to thereby draw electrical power from the support set to the adapter.

15. The system according to claim 13, wherein one or more of the fasteners is a resilient clip configured to reversibly connect the adapter to the conducting element.

16. The system according to claim 11, wherein the adapter comprises an electrical device.

17. The system according to claim 11, wherein one or more conducting element within a support set comprises an insulating coating or layer.

18. The system according to claim 17, wherein one or more fastener of the adapter comprises at least one cutting element configured to pierce the insulating coating or layer to thereby contact the conducting element to thereby allow the adapter to draw electrical power from the conducting element through the insulating coating or layer.

19. The system according to claim 1, wherein the connector comprises a first portion, a contacting element and a second portion.

20. The system according to claim 19, wherein the contacting element comprises a recess configured to receive an end of a conducting element, and a plurality of gripping members arranged around the recess.

21. The system according to claim 19, wherein the first portion is configured to receive the contacting element and to be attached to the second portion.

22. The system according to claim 20, wherein the connector is configured to create an electrical contact to a conducting element inserted therein by urging the plurality of gripping members of the contacting element into contact with the conductive element.
